(19) United States
(12) Patent Application Publication
(10) Pub. No.: US 2009/0140467 A1
(43) Pub. Date: Jun. 4, 2009

(54) Method of Plugging Honeycomb Bodies

(76) Inventors: Melvin Arthur Calkins, JR., Bath, NY (US); Anthony Joseph Cecce, Elmira, NY (US); Jeffrey Donald Roche, Corning, NY (US); Jason Edward Schoonmaker, Painted Post, NY (US); John Charles Speeckaert, Painted Post, NY (US)

Correspondence Address: CORNING INCORPORATED, SP-TI-3-1, CORNING, NY, 14831, US

(21) Appl. No.: 12/277,574

(22) Filed: Nov. 25, 2008

Related U.S. Application Data
(60) Provisional application No. 61/004,820, filed on Nov. 30, 2007.

(51) Int. Cl. H05B 6/00

(52) U.S. Cl. 264/426

(57) ABSTRACT

A method of making a plugged honeycomb structure includes providing a honeycomb structure having a first end face and a second end face and an array of cells extending between the first end face and the second end face. The method includes bringing a first mask into contact with the first end face and injecting a plugging medium through the first flexible mask into at least some of the cells at the first end face. The method further includes removing the mask from the first end face, followed by contacting the first end face with a heated first solid body, wherein the plugging medium in the first end face is heated.

### RELATED APPLICATIONS

This application claims the benefit of U.S. Provisional Application No. 61/004,820, filed Nov. 30, 2007, entitled “Method of Plugging Honeycomb Bodies.”

### BACKGROUND

The invention relates generally to fabrication of plugged honeycomb structures. More specifically, the invention relates to a method of plugging porous ceramic honeycomb bodies.

Honeycomb structures such as used in exhaust gas purification applications have a columnar body with a matrix of intersecting walls defining an array of substantially parallel, longitudinal cells. The cells extend between opposite end faces of the columnar body. The cell walls are porous. For particulate filtration, the cells are selectively end-plugged such that flow entering the columnar body is forced through the porous cell walls before exiting the columnar body. Solid particulates in the flow are retained in the cell walls as the flow passes through the cell walls. By controlling the geometry of the cells, porosity of the cell walls, and filtration area, filtration efficiencies up to and in excess of 90% by weight of the solid particulates can be achieved with these plugged honeycomb structures. Filtration efficiency may be reduced if there are cells in the honeycomb structure that contain holes or cracks in the cell walls or plugs. Thus, identifying and repairing leaking cells is often an important aspect of producing the plugged honeycomb structure. “Pinholes” or “dimples” in the plugs may also have an effect on filtration efficiency.

FIG. 1 shows a partial end view of a honeycomb structure 100 having plugs 102 with pinholes 104 formed in the plugs 102. The pinholes 104 are depressions resembling pin pricks. FIG. 2 shows a partial end view of a honeycomb structure 200 having plugs 202 with dimples 204 formed in the plugs 202. The dimples 204 are depressions resembling scallops. The effective length of a plug may be reduced by the presence of pinholes or dimples, and so to compensate, the actual length of the plug may need to be the sum of the desired effective plug length and the depth of the pinhole or dimple, which would result in a longer plug. Without changing the dimensions of the honeycomb structure, longer plugs tend to reduce the available filtration area of the honeycomb structure.

### SUMMARY

In one aspect, a method of making a plugged honeycomb structure includes the steps of providing a honeycomb structure having a first end face and a second end face and an array of cells extending between the first end face and the second end face, applying a first flexible mask to the first end face, injecting a plugging medium through the first flexible mask into at least some of the cells at the first end face, and peeling off the first flexible mask from the first end face, followed by contacting the first end face with a heated first solid body, wherein the plugging medium in the first end face is heated.

The method may further include the step of terminating contact between the first end face and the heated first solid body and subsequently exposing the honeycomb structure to a drying environment wherein the honeycomb structure is not contacted with any heated bodies.

The method may further include the step of applying a second flexible mask to the second end face and injecting the plugging medium through the second flexible mask into at least some of the cells at the second end face while the first end face contacts the heated first solid body.

The method may further include the step of contacting the second flexible mask with a second solid body while the plugging medium is being injected through the first flexible mask.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

### BRIEF DESCRIPTION OF THE DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain view of the figures may be shown exaggerated in scale or in schematic in the interest of clarity and conciseness.

FIG. 1 is a partial end view of a plugged honeycomb structure with pinholes in the plugs.

FIG. 2 is a partial end view of a plugged honeycomb structure with dimples in the plugs.

FIG. 3 is a flowchart illustrating a method of making a plugged honeycomb structure as disclosed herein.

FIG. 4 shows a honeycomb structure before plugging.

FIG. 5 shows an example of a plugging pattern.

FIG. 6A illustrates a method of plugging cells in a honeycomb structure.

FIG. 6B illustrates a process sequence for making a plugged honeycomb structure.

FIGS. 7A-7C show pinhole formation in a honeycomb structure not made according to the method disclosed herein.

FIGS. 8A-8C show absence of pinholes in a honeycomb structure made according to the method disclosed herein.

FIGS. 9A-9C show dimple formation in a honeycomb structure not made according to the method disclosed herein.

FIGS. 10A-10C show absence of dimples in a honeycomb structure made according to the method disclosed herein.

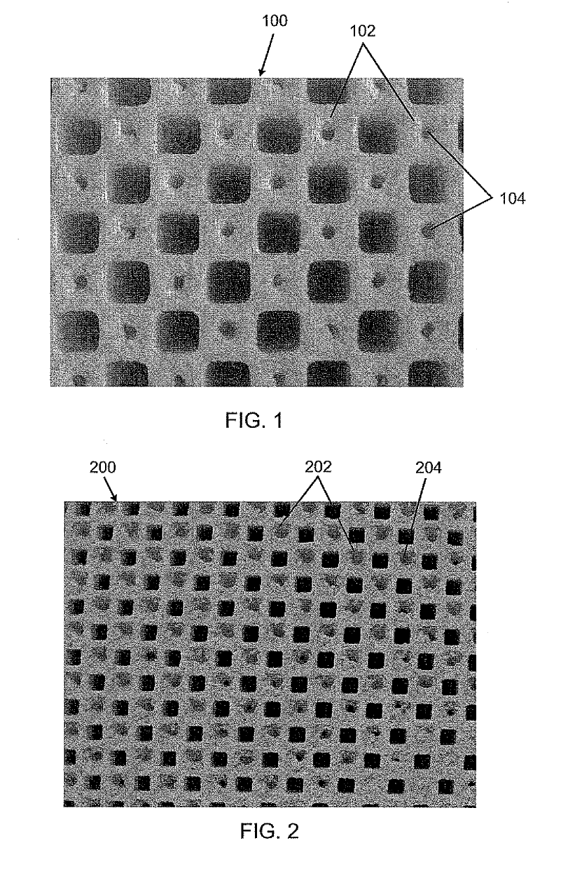

### DETAILED DESCRIPTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details in other instances, well-known features and/or process steps have not been described in detail so as not to unnecessarily obscure the invention. In addition, like or identical reference numerals are used to identify common or similar elements.

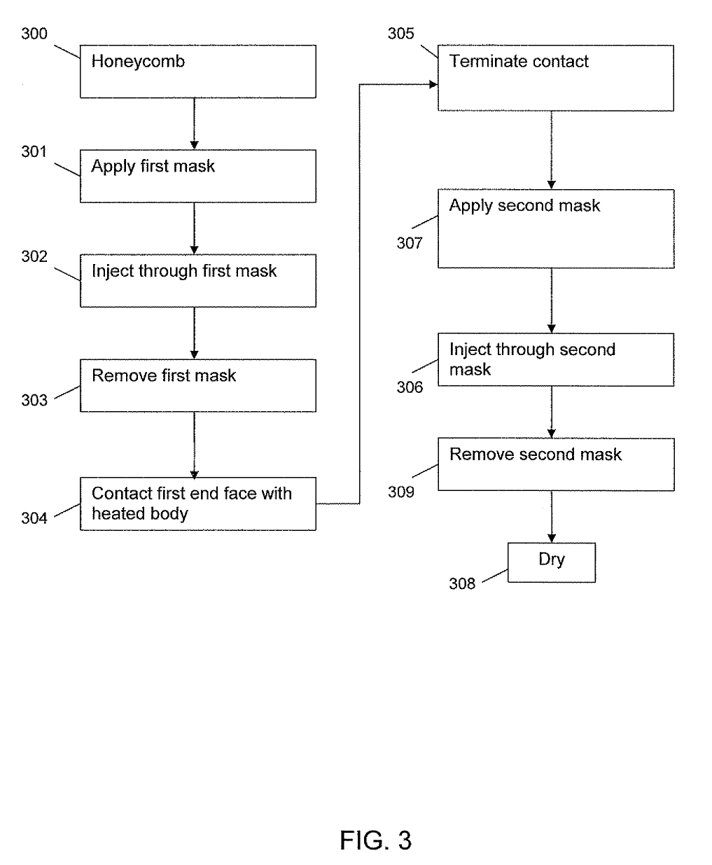

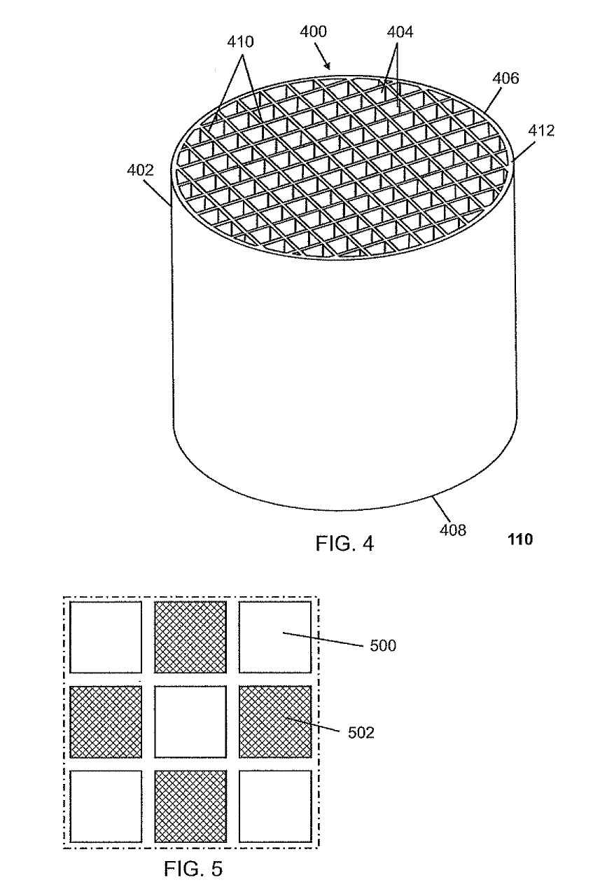

FIG. 3 is a flowchart illustrating a method of making a plugged honeycomb structure as disclosed herein. The method includes providing a honeycomb structure (300). FIG. 4 shows an example of a honeycomb structure 400. The honeycomb structure 400 has a columnar body 402 in which an array of substantially parallel, longitudinal cells 404 is defined by walls 410. The cells 404 extend between opposite end faces 406, 408 of the columnar body 402. The cells 404 are defined by intersecting porous walls 410. The cells 404 and walls 410 are bounded by a skin 412, which may have a circular, oval, or other shape. The cells 404 may have any suitable cross-section such as square cross-section. For diesel particulate filtration applications, the honeycomb structure 400 can be made of a ceramic material such as cordierite, aluminum titanate, or silicon carbide. Any suitable method known in the art may be used to make the honeycomb structure 400. For example, to make a ceramic honeycomb structure 400, a ceramic honeycomb green body is prepared by extruding a plasticized batch of ceramic materials, carbonaceous materials, and moisture through an extrusion die. The carbonaceous materials are typically extrusion and forming aids, such as organic binders, plasticizers, lubricants, and pore formers. After extrusion, the green body is dried and fired to form a ceramic honeycomb body. In the first segment of the firing process, the green body is heated, such as to a temperature less than 650° C., such that carbonaceous materials in the green body react with oxygen in the atmosphere to form volatile materials that can be released from the green body. In the second segment of the firing process, the green body is sintered at a temperature much higher than used in the first segment of the firing process, such as temperatures in a range from 1000° C. to 1400° C. During sintering, carbonaceous materials remaining in the green body may also react with oxygen, and the resulting volatile materials may be released.

Returning again to FIG. 3, the method of making a plugged honeycomb structure includes contacting a first end face of the honeycomb structure (301) with a first mask, such as a flexible mask having openings therethrough. The first mask may be made of a material such as silicone polymer or other non-reactive polymer, and may be formed into a film. The method further includes injecting a plugging medium through the first mask into the first end face of the honeycomb structure (302) while the first mask contacts the first end face. The plugging medium is injected into at least some of the cells in the first end face in order to eventually form plugs in those cells upon further curing or drying or firing of the injected plugging medium. The plugs formed in at least some of the cells are preferably flush or substantially flush with the first end face. The method further includes removing the first mask from the first end face (303), i.e. terminating contact between the first mask and the first end face. Then, the first end face is contacted with a heated first solid body (304). In some embodiments, the plugging medium is forced or inserted further into the cells by the first solid body, i.e. by contact between the plugging medium and the first solid body. In some embodiments, the contact surface of the first solid body is complementary to the surface of the first end face; for example the first end face and the contact surface may be flat. Thus, the contact surface can help to cause the exposed surface of the plugging medium to lie preferably substantially flush, more preferably flush, with the surface of the first end face after the contact has been terminated. The surface of the heated first solid body in contact with the first end face may be made of any suitable smooth, preferably non-stick material such as silicone, Teflon, urethane, aluminum, and steel. The heated first solid body may include a support, which may be made of metal. The heated first solid body may be heated by any suitable means, such as electrical heating. In some embodiments, the plugging medium in the first end face is only partially dried as a result of contact with the heated first solid body. In some embodiments, as a result of the contact between the first end face and the heated first solid body, the plugging medium nearer the heated first solid body is dried but the plugging medium farther away from the heated first solid body remains wet. The method further includes terminating contact between the first end face and the heated first solid body (305). In one embodiment, the plugging medium is flush with the first end face after contact between the first end face and the heated first solid body is terminated. In one embodiment, the first end face is in contact with the heated first solid body for a duration in a range from 1 second to 120 seconds. In another embodiment, the first end face is in contact with the heated first solid body for a duration in a range from 10 seconds to 60 seconds. In another embodiment, the first end face is in contact with the heated first solid body for a duration in a range from 10 second to 30 seconds. In one embodiment, the contact interface between the first end face and the heated first solid body (i.e. the contact surface of the heated first solid body) is maintained at a temperature greater than 37° C. but less than 300° C. In one embodiment, the contact surface of the heated first solid body is maintained at a temperature greater than 65° C. but less than 288° C. In one embodiment, the contact surface of the heated first solid body is maintained at a temperature greater than 65° C. In another embodiment, the contact surface of the heated first solid body is maintained at a temperature greater than 93° C. In one embodiment, injection of the plugging medium through the first flexible mask occurs at a first location, and contacting the first end face with a heated first solid body occurs at a second location different from the first location.

The method further includes contacting a second end face of the honeycomb structure (307) with a second mask, such as a flexible mask, having openings therethrough. The second mask may be made of a material such as silicone polymer or other non-reactive polymer, and may be formed into a film. In some embodiments, the first mask and the second mask are the same mask. The method includes injecting a plugging medium through the second flexible mask into the second end face of the honeycomb structure (306) while the second mask contacts the second end face. The plugging medium is injected into at least some of the cells in the second end face in order to eventually form plugs in those cells upon further curing or drying or firing of the injected plugging medium. The plugs preferably are substantially flush, more preferably flush, with the second end face. In some embodiments, both the first and second masks are brought into contact with the first and second end faces, respectively, before any plugging medium is inserted into the honeycomb body. In other embodiments, the second mask may be brought into contact with the second end face after injecting plugging medium through the first mask, as in FIG. 3. Alternatively, the second mask may be brought into contact with the second end face of the honeycomb structure prior to injecting the plugging medium through the first mask; in this case, for example, the second mask may contact a second solid body while plugging medium is being injected through the first mask, where the second solid body functions as a mechanical stop for holding the honeycomb substrate in place during the insertion of the plugging medium. However, the second mask would not contact the second solid body while the plugging medium is being injected through the second mask. In some embodiments, the first solid body and the second solid body are not the same body. In some embodiments, the second solid body is not heated, whereas the first solid body is heated. After injecting the plugging medium into the second end face, the second flexible mask is removed from the second end face (309) to terminate contact between the second mask and the second end face. In some embodiments, the plugging medium is forced or inserted further into the cells by contact between the plugging medium and the second solid body. In some embodiments, the contact surface of the second solid body is complementary to the surface of the second end face; for example the second end face and the contact surface may be flat. Thus, the contact surface can help to cause the exposed surface of the plugging medium to lie preferably substantially flush, more preferably flush, with the surface of the second end face after the contact has been terminated. In some embodiments, the honeycomb structure is then exposed to a drying environment to allow complete drying of the plugging medium injected into the end faces of the honeycomb structure (308).

Various plugging patterns may be used to achieve desired performances. One common plugging pattern is a checkerboard pattern. As an example, FIG. 5 shows a checkerboard pattern wherein each unplugged cell 500 is bordered on all sides by plugged cells 502, and vice versa. In some embodiments, only one end of each cell is plugged while the other end remains open. Cells having their ends plugged at the inlet end face of the honeycomb structure can be referred to as outlet cells. Cells having their ends plugged at the outlet end face of the honeycomb structure can be referred to as inlet cells. In general, plugged honeycomb structures used for high-efficiency particulate filtration have plugs selectively arranged at both end faces of the honeycomb structures such that flow entering the honeycomb structure is forced through the porous cell walls before exiting the honeycomb structure, allowing the porous cell walls to collect particulate matter separated from the flow.

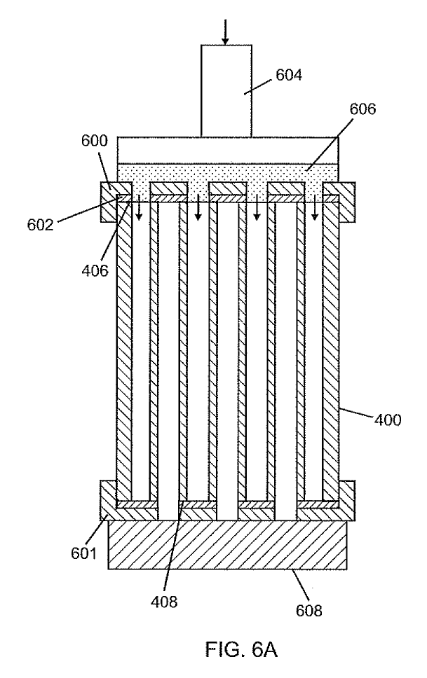

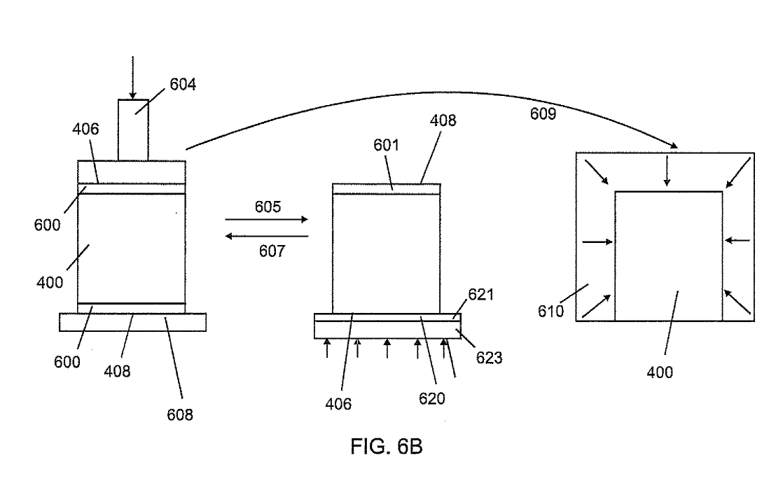

The method of FIG. 3 is further illustrated by reference to FIG. 6A. In FIG. 6A a first mask 600 having a desired plugging pattern of openings has been brought into contact with a first end face 406 of the honeycomb structure 400. The first mask 600 may be secured in place by an adhesive layer 602. A piston 604 injects a plugging medium 606 through the openings in the first mask 600 and into the honeycomb structure 400, i.e. into selected cells in the honeycomb structure 400 through the first mask 600. Any suitable plugging medium 606 may be injected into the honeycomb structure. In some embodiments, the plugging medium 606 is provided as a cement paste. For a ceramic honeycomb structure, the plugging medium 606 may be, for example, a mixture of ceramic material, such as cordierite or silicon carbide, binder, and plasticizer. The second end face 408 of the honeycomb structure 400 may be supported on a second solid body such as a backer plate, which serves as a mechanical stop, 608, where the backer plate 608 helps to prevent the honeycomb structure 400 from moving while the plugging medium 606 is being injected through the first mask 600 and into the first end face 406 of the honeycomb structure 400. In some embodiments, the backer plate 608 is not heated, although in other embodiments the backer plate 68 is heated. In some embodiments, the plugging medium 606 is injected into the first end face 406 of the honeycomb structure 400, then, the first mask 600 is peeled off the honeycomb structure 400, and the first end face 406 is contacted with a heated first solid body.

As illustrated in FIG. 6B, after insertion of the plugging medium at the first end face 406 is completed, and the plugging medium is preferably flush with the first end face 406, contact between the second end face 408 and the second solid body is terminated, and the first end face 406 may be placed in contact with a heated first solid body 620 are shown as a backer support plate 623 having a smooth preferably non-stick material 621 forming its contact surface, the arrows indicating heat flush into the body 620. The first solid body 620, or backer plate, can act as a mechanical stop to axial translation of the honeycomb structure 400. In this position, plugging medium 606 can be injected into the second end face 408 of the honeycomb structure through openings in a second mask 601 in contact with the second end face 408. In one embodiment, the heated first solid body 620 is provided at a separate location from the location in which the plugging medium 606 is injected into the first end face 406. This is illustrated, for example, in FIG. 6B. In FIG. 6B, arrow 605 shows the honeycomb structure 400 moving to a different station, where the first end face 406 (containing plugging medium 606) is placed in contact with the heated first solid body 620. The surface 621 of heated first solid body 620 may comprise a non-reactive material 621, such as silicone, applied on a metal support 623. After heating the first end face 406 for a selected duration, the honeycomb structure 400 may then be returned to the previous station, as illustrated by arrow 607 to allow for plugging of the second end face 408 of the honeycomb structure. Alternatively, another plugging station may be provided downstream of the station at which the first end face 406 is contacted with the heated first solid body 620 in order to allow plugging of the second end face 408 of the honeycomb structure 400.

Alternatively, instead of moving the honeycomb structure 400 between two stations, as indicated by arrows 605, 607 in FIG. 6B, the second solid body functions as a mechanical stop for holding the honeycomb structure 400 in place while injecting plugging medium into the second end face 408.

In another embodiment, a double piston arrangement is used to simultaneously inject the plugging medium 606 into both end faces 406, 408 of the honeycomb substrate. Then, the first mask 600 is removed, and the first end face 406 is contacted with a heated first solid body, which may be provided at the location where the plugging medium is injected or at a different location. The second mask 601 likewise can be removed and optionally contacted with a heated solid body.

In both the single-piston and double-piston arrangement, the second mask 601 is removed after injecting the plugging medium into the second end face 408. Then, the honeycomb structure 400 is exposed to a drying environment to allow complete drying or curing of the plugging medium injected through the first and second end faces 406, 408. In FIG. 6B, for example, the honeycomb structure 400 moves from the plugging station into a drying environment 610, as illustrated by arrow 609. In one embodiment, the honeycomb structure 400 is not contacted with any heated bodies in the drying environment 610 and drying of the honeycomb structure 400 is achieved by, for example, convection or radiation or both. Because first end face 406 is “pre-heated” by the first solid body 620, the then more durable first end face 406 can be placed on a suitable surface in the drying environment 410.

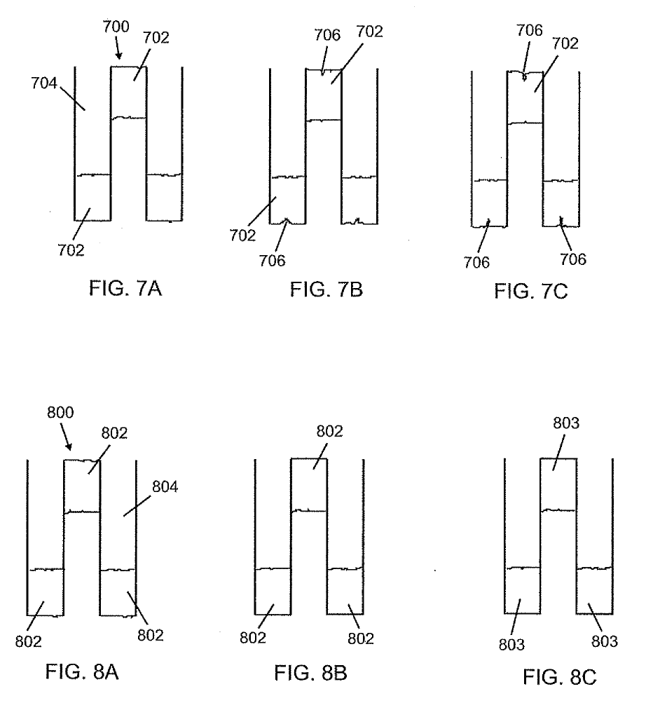

FIGS. 7A-7C show pinhole formation in a plugged honeycomb structure that is not made as described above. FIGS. 7A-7C are shown for comparative purposes only and do not represent plugged honeycomb structures made according to the method described herein. FIG. 7A shows a portion of a honeycomb structure 700 immediately after insertion of plugging medium 702in the ends of cells 704. At this point, the plugging medium 702 is still wet. FIGS. 7B and 7C show the progressive formation of pinholes in the inserted plugging material 702 with time.

FIGS. 8A-8C show absence of pinhole formation in a plugged honeycomb structure made according to the method described herein. FIG. 8A shows a portion of a plugged honeycomb structure 800 immediately after insertion of plugging medium into the ends of cells 804. At this point, the inserted plugging material 802 is still wet. FIG. 8B shows the inserted plugging material 802 after contact with a heated surface. FIG. 8C shows the formed plugs 803 wherein no pinholes in the plugs are shown.

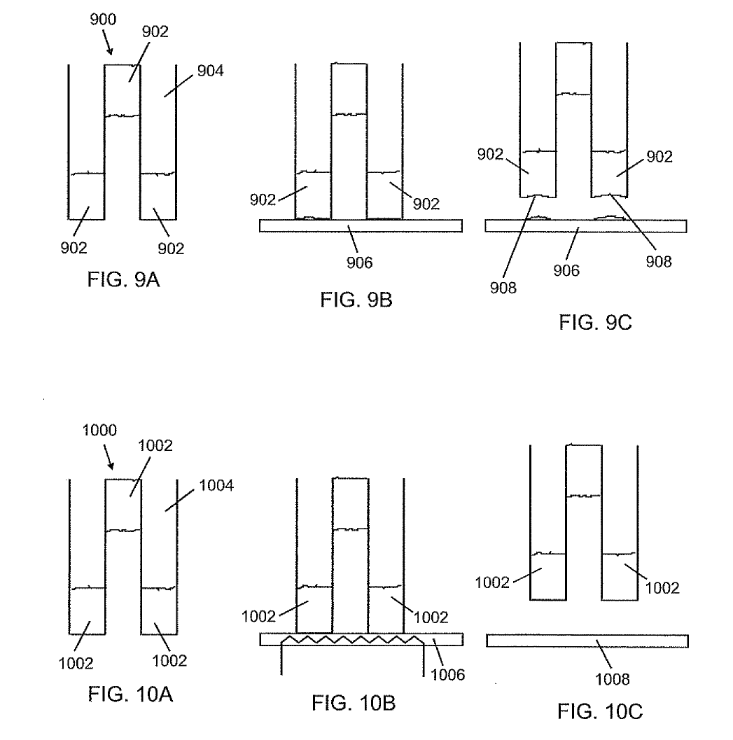

FIGS. 9A-9C show dimple formation in a honeycomb structure that is not made according to the process described herein. FIGS. 9A-9C are shown for comparative purposes only and do not represent plugged honeycomb structures made according to the method described herein. FIG. 9A shows a portion of a plugged honeycomb body 900 immediately after insertion of plugging material 902 in the ends of cells 904. At this point, the plugging material 802 is still wet. FIG. 9B shows the wet material 902 in contact with a surface 906 that is not heated. FIG. 9C shows that a portion of the wet material 902 sticks to the surface 906 upon removal of the body 900 from the surface 902, resulting in dimples 908 in the material 902 and subsequently in formed plugs.

FIGS. 10A-10C show absence of dimple formation in a plugged honeycomb structure that is immediately contact heated as described above with reference to the method disclosed herein. FIG. 10A shows a portion of a honeycomb structure 1000 immediately after inserting of plugging material in the ends of cells 1004. At this point, the material 1002 is still wet. FIG. 10B shows the wet material 1002 in contact with a heated surface 1006, where the wet material 1002 are heated by the heated surface 1006 immediately after they are inserted in the honeycomb structure and contact heated as described herein above. FIG. 10C shows that the preheated material 1002 now does not stick to the heated surface 1006 or other (subsequent) surfaces, such as surface 1008, after heat treatment.

Pinhole and dimples, generally referred to as depressions, can reduce the effective length of plugs, where effective plug length is described as the total plug length less the depth of a void area left by a surface depression. By removing dimples and pinholes (or depressions) from the plug, the effective length of the plug becomes essentially the same as the plug length, enabling wider operating window for plug depth. Plugs can also be made shorter if they do not contain depressions such as dimples and pinholes, thereby allowing more of the surface area of the cell walls to be available for filtration. Removal of dimples and pinholes may also increase the resistance of the plugs to formation of cracks and holes when the plugged honeycomb substrate is in use. Minimizing or eliminating surface defects according to the method described above also avoids additional processing steps to inspect the plugged honeycomb structure and ensure that the surface defects are within acceptable limits.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of making a plugged honeycomb structure comprising the steps of:
providing a honeycomb structure having first end face and a second end face and an array of cells extending between the first end face and the second end face;
contacting the first end face with a first mask having openings;
injecting a plugging medium through the openings in the first mask and into at least some of the cells at the first end face; and
removing the first mask from the first end face, followed by contacting the first end face with a heated first solid body, wherein the plugging medium in the first end face is heated.

2. The method of claim 1 further comprising injecting the plugging medium into the second face while the first end face contacts the heated first solid body, wherein the heated first solid body provides a mechanical stop for holding the honeycomb structure in place while the plugging medium is being injected into the second end face.

3. The method of claim 1 further comprising terminating contact between the first end face and the heated first solid body and then exposing the honeycomb structure to a drying environment wherein the honeycomb structure is not contacted with any heated body.

4. The method of claim 3 wherein the drying environment is convective heating, radiative heating, or a combination thereof.

5. The method of claim 1 further comprising contacting the second end face with a second mask having openings and injecting the plugging medium through the openings in the second mask and into at least some of the cells at the second end face while the first end face contacts the heated first solid body.

6. The method of claim 5 wherein the second mask contacts the second end face prior to injecting the plugging medium through the first mask.

7. The method of claim 5 wherein the second mask contacts the second solid body while the plugging medium is being injected through the first mask.

8. The method of claim 7 wherein the second mask does not contact the second solid body while the plugging medium is being injected through the second mask.

9. The method of claim 7 wherein the second solid body provides a mechanical stop for holding the honeycomb structure in place while the plugging medium is being injected into the first end face.

10. The method of claim 7 wherein the second solid body is not heated.

11. The method of claim 7 wherein the second solid body is not the first solid body.

12. The method of claim 5 wherein the second mask contacts the second end face after injecting the plugging medium through the first mask.

13. The method of claim 12 wherein the second end face contacts a second solid body while the plugging medium is being injected through the first mask.

14. The method of claim 13 wherein the second mask does not contact the second solid body while the plugging medium is being injected through the second mask.

15. The method of claim 13 wherein the second solid body provides a mechanical stop for holding the honeycomb substrate in place while the plugging medium is being injected into the first end face.

16. The method of claim 13 wherein the second solid body is not heated.

17. The method of claim 13 wherein the second solid body is not the first solid body.

18. The method of claim 1 wherein the first solid body comprises a silicone polymer surface.

19. The method of claim 1 wherein the plugging medium in the first end face is only partially dried by contact with the heated first solid body.

20. The method of claim 1 wherein, during contact between the first end face and the heated first solid body, the plugging medium nearer the heated first solid body is dried but the plugging medium farther away from the first solid body remains wet.

21. The method of claim 1 further comprising terminating contact between the first end face and the heated first solid body, wherein the plugging medium is flush with the first end face after contact between the first end face and the heated first solid body is terminated.

22. The method of claim 1 wherein the first end face is in contact with the heated first solid body for 1 second to 120 seconds.

23. The method of claim 1 wherein a contact surface of the heated first solid body is maintained at a temperature greater than 37° C. but less than 300° C.
